(19) United States
(12) Patent Application Publication
(10) Pub. No.: US 2024/0033894 A1
(43) Pub. Date: Feb. 1, 2024

(54) ELECTRICALLY DRIVABLE DEVICE

(71) Applicant: HOSIDEN CORPORATION, Osaka (JP)

(72) Inventors: Kosuke INAGE, Osaka (JP); Tadashi HANAI, Osaka (JP); Eiji SATO, Osaka (JP)

(21) Appl. No.: 18/222,544

(22) Filed: Jul. 17, 2023

(30) Foreign Application Priority Data
Jul. 27, 2022 (JP) 2022-119756

(51) Int. Cl. B25F 5/02

(52) U.S. Cl. CPC B25F 5/026; B24B 23/028

(57) ABSTRACT

An electrically drivable device includes a device body including an actuator and a handle attachable to and detachable from the device body. The handle includes a connector separably connectable with the device body, a pressure receiver displaceable in response to a gripping force with which the user grips the handle, a magnet control mechanism configured to operate a permanent magnet in conjunction with the displacement of the pressure receiver, and a frame holding the pressure receiver in such a manner that the pressure receiver is displaceable, and containing the magnet control mechanism. The device body includes a magnetic sensor configured to, in response to the pressure receiver being displaced with the handle attached to the device body, detect magnetism that the permanent magnet applies through the connector.

### CROSS REFERENCE TO RELATED APPLICATION

This application is based on and claims priority under 35 U.S.C. Section 119 to Japanese Patent Applications No. 2022-119756 filed on Jul. 27, 2022 the entire content of which are incorporated herein by reference.

### TECHNICAL FIELD

This disclosure relates to an electrically drivable device including (i) a device body including an operation section drivable by an actuator and (ii) a handle attachable to and detachable from the device body.

### RELATED ART

Conventional electrically drivable devices drivable by an actuator include disc grinders and electrically operable drills. Such an electrically drivable device may include a handle attachable for use and detachable for disuse. Examples include those disclosed in the respective specifications of U.S. Patent Application Publications Nos. 2018/0272494 and 2014/0231113.

The electrically drivable device disclosed in the specification of U.S. Patent Application Publication No. 2018/0272494 includes a handle including a bolt with an externally threaded portion protruding from the leading end of the handle. Threadedly engaging the externally threaded portion with the device body attaches the handle to the device body. The externally threaded portion contains a magnet, whereas the device body includes a Hall device. This allows the electrically drivable device to detect that the handle has been attached to the device body.

The electrically drivable device disclosed in the specification of U.S. Patent Application Publication No. 2014/0231113 includes a handle containing an element such as a pressure sensor and a device body including a detection circuit. The pressure sensor is configured to transmit an electric signal to the detection circuit. This allows the electrically drivable device to detect that the user has gripped the handle.

### SUMMARY

The electrically drivable device disclosed in the specification of U.S. Patent Application Publication No. 2018/0272494, which is capable of detecting that the handle has been attached to the device body, is incapable of detecting that the user has gripped the handle. Further, with the handle detached from the device body, the magnet in the externally threaded portion may attract a magnetic substance such as iron powder onto the surface of the external thread, which may in turn, for instance, cause the magnetic substance (foreign substance) to be stuck between the external thread and the mating internal thread and result in a defect in attaching the handle to the device body.

The electrically drivable device disclosed in the specification of U.S. Patent Application Publication No. 2014/0231113, which is capable of detecting that the user has gripped the handle, requires an electric contact between the handle and the device body for electric power supply and communication. The electric contact may suffer from a conduction failure due to, for example, stain or rust, which may in turn cause the electrically drivable device to fail to detect the user's grip. Further, the handle needs to include in the externally threaded portion an electric wire extending to the electric contact, which may lead to the bolt having a decreased strength and/or the handle including a large bolt.

The above circumstances have led to a demand for an electrically drivable device including a device body and an attachment with a connector for connection with the device body and capable of detecting whether the attachment is being gripped, with the connector unaffected.

An electrically drivable device according to this disclosure includes: a device body; and an attachment attachable to and detachable from the device body, the attachment including: a connector connectable with the device body; at least one pressure receiver displaceable inward in response to a gripping force with which a user grips the attachment; a permanent magnet; a magnet control mechanism configured to move the permanent magnet or change an orientation thereof in conjunction with the displacement of the at least one pressure receiver; and a frame holding the at least one pressure receiver in such a manner that the at least one pressure receiver is displaceable, and containing the magnet control mechanism, the device body including a magnetic sensor configured to, in response to the at least one pressure receiver being displaced with the attachment attached to the device body, detect magnetism that the permanent magnet applies through at least a portion of the connector.

The electrically drivable device is configured such that in response to the user gripping the attachment and thereby the magnet control mechanism moving the permanent magnet or changing its orientation, the magnetic sensor detects magnetism that the permanent magnet applies through at least a portion of the connector. The magnet control mechanism is contained in the frame and mechanically operable in response to the user's grip. This eliminates the need for the connector to include components such as an electric contact and an electric wire. The permanent magnet and the magnet control mechanism, which are contained in the frame, do not easily attract a magnetic substance such as iron powder onto, for example, the connector while the user is not gripping the attachment. This reduces the risk of the magnetic substance (foreign substance) being stuck between the attachment and the device body and the resulting defect in attaching the attachment. The above configuration therefore provides an electrically drivable device including a device body and an attachment with a connector for connection with the device body and capable of detecting whether the attachment is being gripped, with the connector unaffected. The electrically drivable device requires no electric contact and has only a reduced risk of an attachment defect caused by a foreign substance being stuck between the attachment and the device body.

The electrically drivable device may be configured such that the device body includes a connection keeper configured to be coupled with a coupler of the attachment to allow the attachment to be coupled with the device body.

The connection keeper allows the attachment to be coupled with the device body with use of a coupler.

The electrically drivable device may be configured such that the connector includes a coupler made of a magnetic material, the device body includes a connection keeper configured to be coupled with a tip of the coupler to allow the attachment to be coupled with the device body, and the permanent magnet applies the magnetism to the magnetic sensor through the coupler.

The coupler made of a magnetic material allows the permanent magnet to apply its magnetism to the magnetic sensor through the coupler. This increases the accuracy in detecting magnetism without decreasing the distance between the permanent magnet and the magnetic sensor. The coupler, which is made of a magnetic material, eliminates the need to separately include a yoke to allow magnetism to be applied to the magnetic sensor, thereby reducing the number of parts involved.

The electrically drivable device may be configured such that the magnet control mechanism positions magnetic poles of the permanent magnet such that while the at least one pressure receiver is not displaced, the magnetism does not satisfy a first condition and that in response to the at least one pressure receiver being displaced by the gripping force, the magnetism starts to satisfy a second condition.

While the attachment is unattached, that is, the user is not gripping the attachment, magnetism that the permanent magnet applies to the magnetic sensor does not satisfy the first condition. If the attachment is attached, and the user is gripping the attachment improperly, the magnetism does not satisfy the second condition, so that the electrically drivable device is unable to start supplying electric current to an actuator included in the electrically drivable device such as an electric motor. If the user has gripped the attachment properly, the electrically drivable device determines that the magnetism satisfies the second condition, so that the electrically drivable device is able to start supplying electric current to the actuator.

The electrically drivable device may be configured such that while the magnetism does not satisfy the first condition, the electrically drivable device is unable to receive electric current, in response to the magnetism starting to satisfy the first condition as a result of the displacement of the at least one pressure receiver, the electrically drivable device starts to be able to receive electric current, while the magnetism satisfies the first and second conditions, the electrically drivable device is able to start receiving electric current, and even if, while the electrically drivable device is receiving electric current, the magnetism has started to fail to satisfy the second condition while satisfying the first condition, the electrically drivable device is able to continue receiving electric current.

In response to, while the magnetism satisfies the first condition, the user gripping the attachment so that the magnetism starts to satisfy the second condition, the electrically drivable device is, for instance, able to start supplying electric current to an actuator included in the electrically drivable device such as an electric motor. In response to the user weakening the grip of the attachment while electric current is being supplied as above, the magnetism starts to fail to satisfy the second condition while satisfying the first condition. The electrically drivable device is configured to continue the electric current supply even in the above case.

The electrically drivable device may be configured such that in response to the at least one pressure receiver being displaced by the gripping force, the magnet control mechanism positions or orients the magnetic poles of the permanent magnet such that the magnetism satisfies the first condition and fails to satisfy a third condition, and the electrically drivable device is able to save electric current if the magnetism satisfies the first condition and fails to satisfy the third condition.

With the above configuration, in response to the user weakening the grip of the attachment after the magnetism satisfied the second condition, the magnetism satisfies the third condition, in which case the electrically drivable device, for instance, saves electric current to be supplied to an actuator included in the electrically drivable device such as an electric motor. The electrically drivable device is thereby configured to continue the supply of electric current with an upper limit, for example.

The electrically drivable device may be configured such that the magnet control mechanism includes: a rotor holding the permanent magnet in such a manner that the permanent magnet is rotatable; and a gear unit configured to convert the displacement of the at least one pressure receiver into a rotation and transmit the rotation to the rotor, and in response to the at least one pressure receiver being displaced, the rotor rotates to bring one of the magnetic poles of the permanent magnet close to the coupler for the magnetism to be applied to the magnetic sensor.

With the above configuration, the user gripping the attachment causes the magnet control mechanism to rotate the permanent magnet to move its magnetic poles or change the orientation of the magnetic poles. This brings the magnetic poles close to the coupler and thereby allows the magnetic sensor to detect the magnetism.

The electrically drivable device may be configured such that the at least one pressure receiver includes a pair of pressure receivers opposite to each other across a frame axis of the frame which frame axis extends in a longitudinal direction of the frame, the pressure receivers are configured such that in response to the user gripping the attachment, at least either of the pressure receivers is displaced in such a direction that the pressure receivers become closer to each other, and the gear unit includes: at least one pinion gear meshing with a rack gear on each of a pair of operation plates movable in conjunction with the respective pressure receivers; and a plurality of interlocking gears configured to transmit a rotation of the at least one pinion gear to the rotor.

The above configuration involves a pair of pressure receivers and a pair of operation plates operable in conjunction with the respective pressure receivers and including respective rack gears. The above configuration also involves a pinion gear meshing with the rack gears. The electrically drivable device is configured to rotate the pinion gear and transmit the rotation to the rotor through a plurality of interlocking gears. This reliably rotate the permanent magnet to change the intensity of magnetism (magnetic flux density) to be applied to the magnetic sensor or switch the magnetic poles for control of the magnetism.

The electrically drivable device may be configured such that the at least one pinion gear includes: a first pinion gear; and a second pinion gear, the first pinion gear meshes with a first rack gear, the first rack gear being the rack gear on a first operation plate of the pair of operation plates, the second pinion gear meshes with a second rack gear, the second rack gear being the rack gear on a second operation plate of the pair of operation plates, and the attachment includes a coupler rack gear interlocking the first pinion gear with the second pinion gear.

The first and second pinion gears, in response to displacement of the pressure receivers, rotate in conjunction with each other as interlocked by a coupler rack gear. Thus, gripping the attachment (pressure receivers) unevenly still causes the pressure receivers to be translated while in parallel to each other for transmission of the displacement to the gear unit.

The electrically drivable device may be configured such that the attachment includes in the frame an urging member configured to, in response to the at least one pressure receiver being displaced, urge the at least one pressure receiver away from a frame axis of the frame which frame axis extends in a longitudinal direction of the frame.

The urging member causes the pressure receiver to rapidly return to the released position in response to the user releasing the attachment.

The electrically drivable device may be configured such that the urging member includes at least one of an elastomer, a coil spring, or a plate spring.

With the above configuration, the urging member ensures its required urging force by use of at least one of an elastomer, a coil spring, a plate spring, or any other option with an equivalent urging force.

### BRIEF DESCRIPTION OF DRAWINGS

FIG. 1 is a perspective view of a disc grinder.

FIG. 2 is an exploded perspective view of the handle of a disc grinder.

FIG. 3 is a cross-sectional view of a handle taken in a direction orthogonal to the direction in which operation levers are operable.

FIG. 4 is a cross-sectional view of a handle taken in the direction in which operation levers are operable.

FIG. 5 provides (i) a cross-sectional view of a handle containing a permanent magnet and not gripped for operation of operation levers and how the permanent magnet is oriented and (ii) a cross-sectional view of the handle as gripped and how the permanent magnet is oriented.

FIG. 6 is a transverse cross-sectional view of a handle.

### DESCRIPTION OF EMBODIMENTS

The description below deals with an embodiment of this disclosure with reference to drawings.

The present embodiment is a disc grinder A as an example electrically drivable device. This disclosure is, however, not limited to the embodiment below, and may be altered variously without departing from its scope.

### Basic Configuration

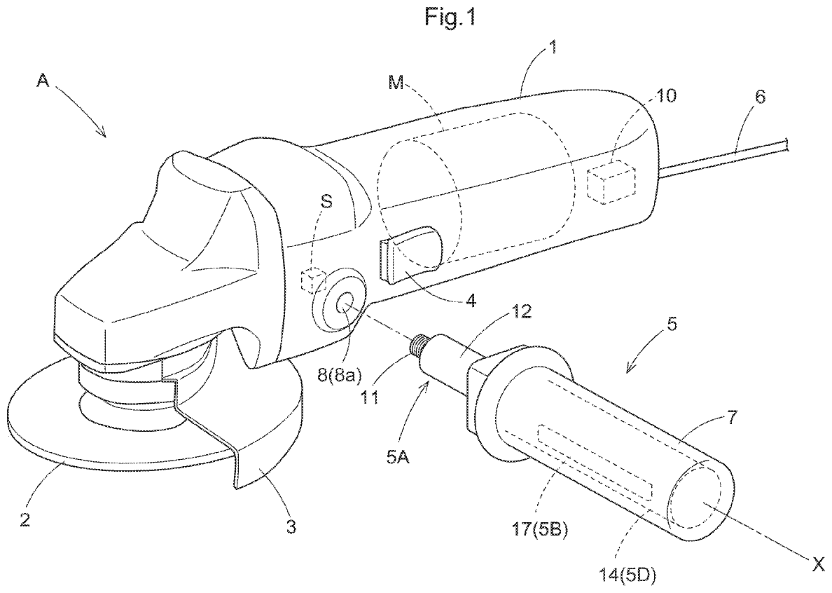

As illustrated in FIG. 1, the disc grinder A includes a device body 1, a disc 2, a disc cover 3, an electric power switch 4, and a handle 5. The device body 1 contains an electric motor M. The disc 2 is at an end of the device body 1. The disc cover 3 covers a portion of the edge of the disc 2. The electric power switch 4 serves to turn the electric motor M on and off. The handle 5 (which is an example of the “attachment”) is attached to the outer surface of the device body 1.

The disc grinder A includes a feeder line 6, and is configured to receive electric power for driving the electric motor M through the feeder line 6. The device body 1 has a cylindrical shape as a whole. The handle 5 has a diameter smaller than the diameter of the device body 1, and extends along a frame axis X orthogonal to the longitudinal direction of the device body 1.

The disc grinder A is configured such that the disc 2 is a grindstone rotatable at high speeds to grind a workpiece. The user holds the device body 1 with their right hand and grips (holds) the handle 5 with their left hand to operate the disc grinder A.

The handle 5 is (attachable to and) detachable from the device body 1. The disc grinder A includes a control circuit 10 configured to enable the electric motor M to be driven in response to, with the handle 5 properly attached to the device body 1, the user gripping the handle 5 with a force (gripping force) over a predetermined value.

The handle 5 is also detachably attachable on the side opposite to the side illustrated in FIG. 1 to allow the user to grip (hold) the handle 5 with their right hand to operate the disc grinder A (not illustrated in the drawings). The control circuit 10 is configured to also enable the electric motor M to be driven in response to the user gripping the handle 5 as attached on the opposite side.

The control circuit 10 disables the supply of electric current to the electric motor M in response to the electric power switch 4 being turned on if the user is not gripping the handle 5 or if the user is gripping the handle 5 with a very weak gripping force. The control circuit 10 disables the supply of electric current to the electric motor M if the handle 5 is attached to the device body 1 improperly. The control circuit 10 is capable of, in response to the gripping force becoming weak after the user grips the handle 5 for electric current to be supplied to the electric motor M, reducing the electric current supply and keeping the reduced state to save electric current. These control operations will be described later.

### Handle

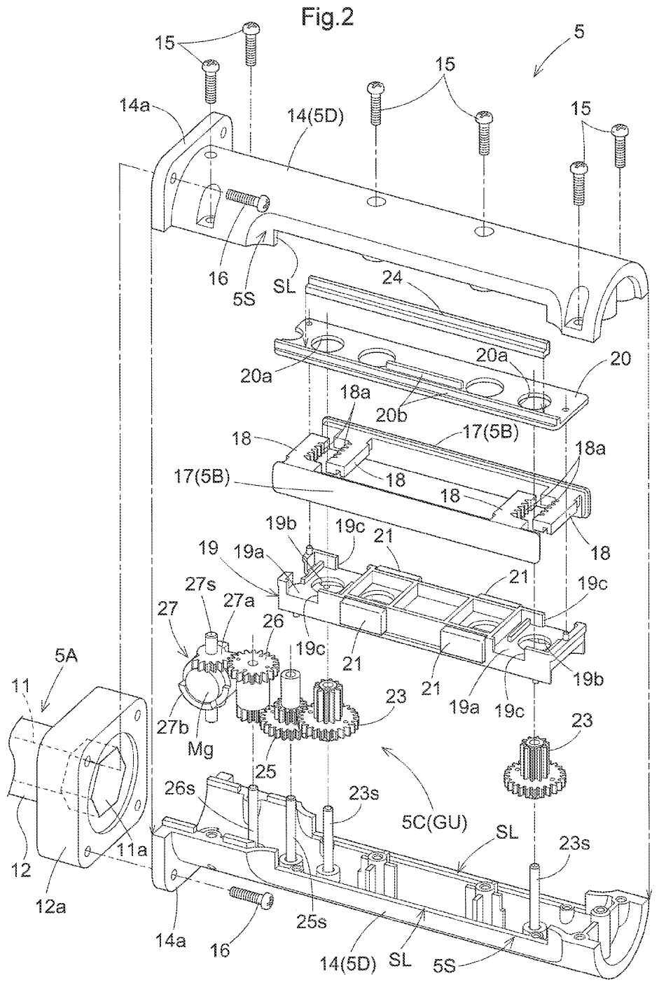

As illustrated in FIGS. 1 and 2, the handle 5 includes a connector 5A, a pair of pressure receivers 5B, a permanent magnet Mg, a magnet control mechanism 5C, and a cylindrical frame 5D. The connector 5A is separably connectable to the device body 1. The pressure receivers 5B are displaceable in response to the user's gripping force. The magnet control mechanism 5C is configured to move the permanent magnet Mg in conjunction with the displacement of the pressure receivers 5B.

The pressure receivers 5B include respective operation levers 17 held by the frame 5D in such a manner as to be displaceable. The frame 5D contains the permanent magnet Mg and the magnet control mechanism 5C in its internal space.

The handle 5 is provided with a rubber cover 7 made of a flexible rubber and covering the outer face of each operation lever 17 and the outer surface of each frame body 14 (described later) of the frame 5D. The rubber cover 7 protects the pressure receivers 5B and prevents dust from entering the frame 5D. The rubber cover 7 covers the frame 5D uniformly along its entire circumference. This makes it difficult to, for instance, tying a piece of string around the rubber cover 7 to keep the pressure receivers 5B displaced. This in turn prevents the user from using the disc grinder A as if the user is gripping the handle 5 while the user is not, and thereby prevents the user from using the disc grinder A while gripping only the device body 1 with a single hand.

### Connector of Handle

As illustrated in FIGS. 1,2, and 5, the connector 5A includes a bolt 11 and a holder 12. The bolt 11 (which is an example of the “coupler”) is made of a magnetic material such as steel. The holder 12 contains the bolt 11 in such a manner that the bolt 11 exposes its tip. The bolt 11 and the holder 12 are coaxial with the frame axis X. The holder 12 integrally includes a flange 12a orthogonal to the frame axis X.

The handle 5 is configured such that the bolt 11 has a head 11 a fitted in the flange 12a so that the bolt 11 and the holder 12 are rotatable integrally with each other.

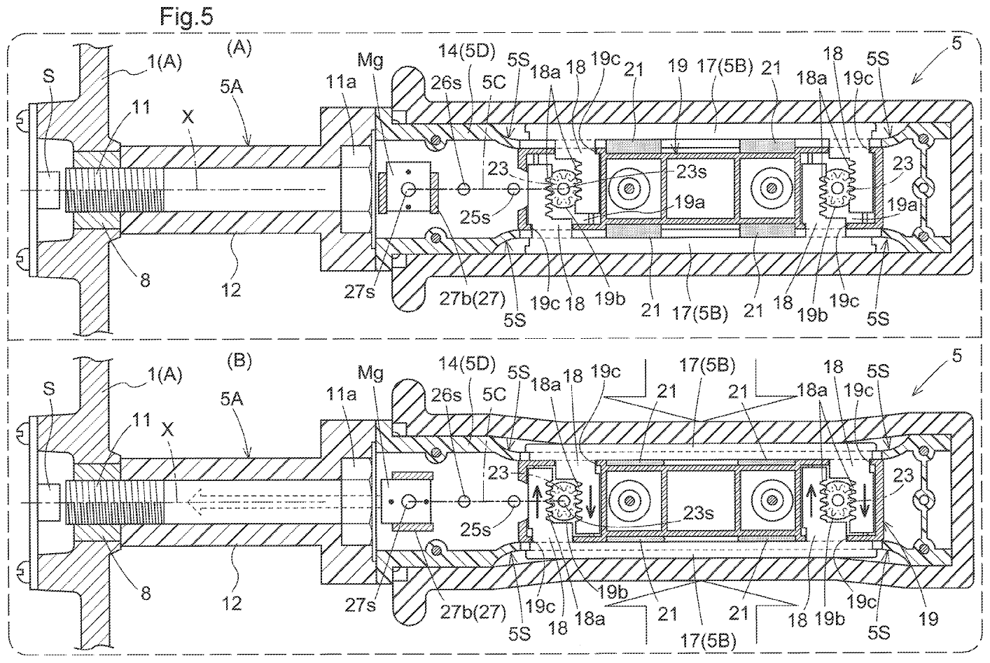

As illustrated in FIGS. 1 and 5, the device body 1 includes a nut 8 (which is an example of the “connection keeper”) into which to screw the bolt 11. The device body 1 contains a magnetic sensor S proximate to the nut 8. The magnetic sensor S is in the form of a Hall device configured to detect magnetism applied by the permanent magnet Mg through the bolt 11 and transmit a detection signal to the control circuit 10. The magnetic sensor S may alternatively be in the form of a magnetoresistive element or a semiconductor magnetoresistive element.

The handle 5 is rotated in its entirety in such a manner as to screw the tip of the bolt 11 into the nut 8 (connection keeper) for attachment to the device body 1. As illustrated in FIG. 5, attaching the handle 5 to the device body 1 brings an end of the holder 12 into contact with the outer surface of the device body 1. This defines a limit on how much the bolt 11 can be screwed into the nut 8, and allows the tip of the bolt 11 to be proximate to the magnetic sensor S. Rotating the handle 5 in its entirety in the direction reverse to the attachment direction detaches the handle 5 from the device body 1.

The device body 1 includes at least one nut 8 (connection keeper). If the device body 1 includes two nuts 8, the magnetic sensor S is proximate to both nuts 8.

### Frame of Handle

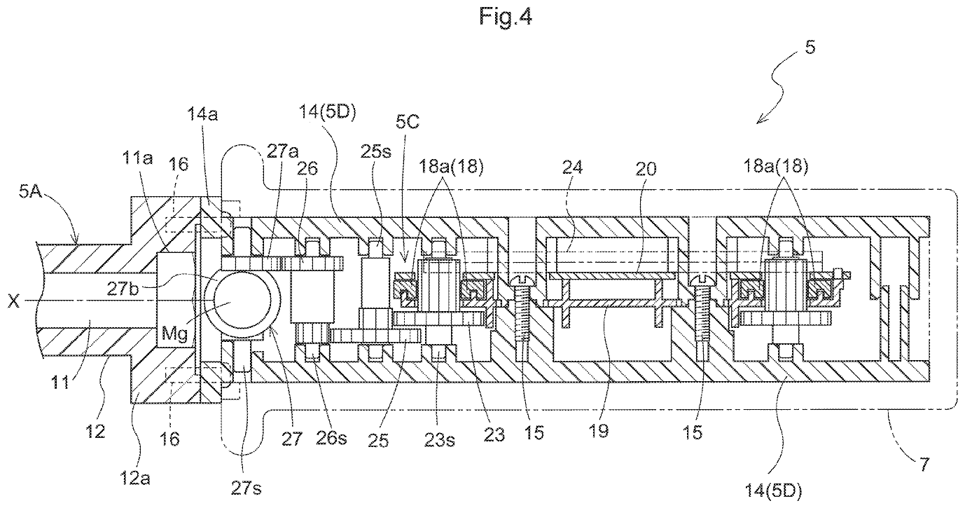

As illustrated in FIGS. 2, 4, and 6, the frame 5D includes a pair of semi-cylindrical frame bodies 14 each made of resin. Coupling the frame bodies 14 with each other with use of coupler screws 15 provides a cylindrical frame 5D. The frame bodies 14 each integrally include a coupler body 14a at the end proximate to the holder 12. The coupler body 14a protrudes outward of the frame body 14 orthogonally to the frame axis X (see FIG. 1).

Coupling the frame bodies 14 with each other and fixing the coupler bodies 14a to the flange 12a with use of fixing screws 16 fixes the frame 5D to the connector 5A.

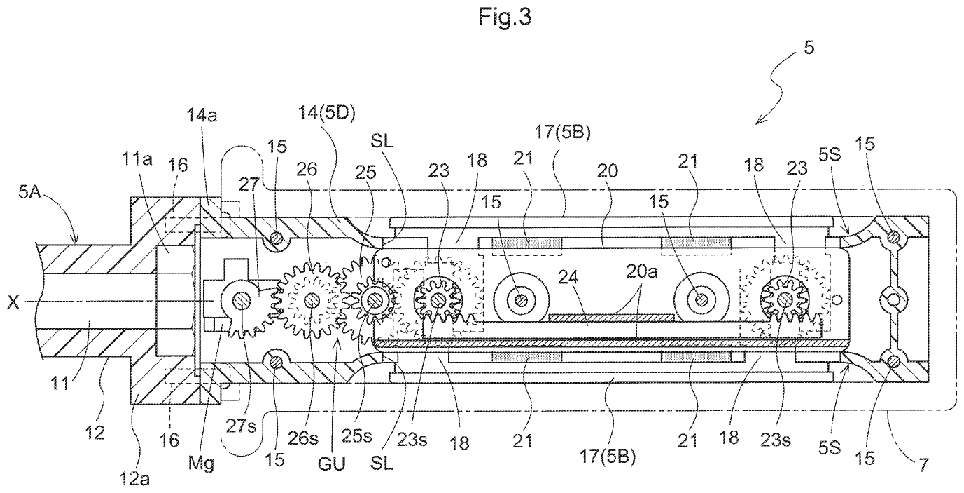

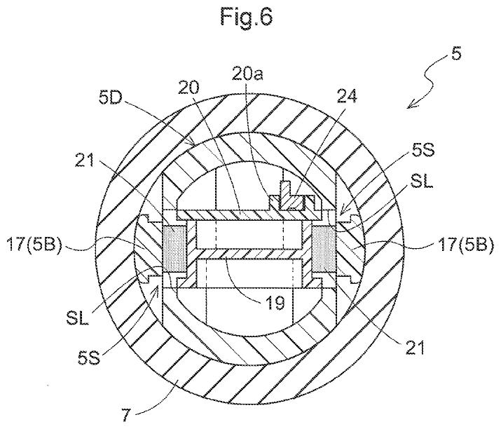

As illustrated in FIGS. 3 and 6, the frame 5D has, at respective mating surfaces, a pair of slits SL through which operation plates 18 of the pressure receivers 5B are disposed (see also FIG. 2). The slits SL are opposite to each other across the frame axis X. The frame 5D has a pair of depressions 5S in the respective outer surfaces of the frame bodies 14 and outward of the respective slits SL (that is, farther from the frame axis X than the respective slits SL). The depressions 5S are in the form of spaces in which the respective operation levers 17 (included in the pressure receivers 5B) are disposed.

The depressions 5S form spaces between the outer surface of the frame 5D and the inner surface of the rubber cover 7 as illustrated in FIG. 6 to facilitate the user pressing the operation levers 17 with a gripping force.

### Pressure Receivers of Handle

As illustrated in FIGS. 2 and 5, the pressure receivers 5B are opposite to each other across the frame axis X. The pressure receivers 5B each include an operation lever 17 and a pair of operation plates 18 protruding radially inward of the handle 5 from those respective ends of the operation lever 17 which are opposite to each other along the frame axis X.

The operation plates 18 are so positioned as to be disposed through the slits SL. The operation plates 18 each include a rack gear 18a.

As illustrated in FIGS. 2 to 5, the handle 5 includes a guide block 19 and a guide plate 20. The guide block 19 and the guide plate 20 hold the pressure receivers 5B in such a manner that inside the handle 5, the operation plates 18 of one pressure receiver 5B each have its rack gear 18a facing the rack gear 18a of the corresponding operation plate 18 of the other pressure receiver 5B.

The guide block 19 coincides with each operation lever 17 as viewed in the direction in which the operation lever 17 is operated. As illustrated in FIG. 2, the guide block 19 has two depressions 19a at the respective ends, two holes 19b also at the respective ends, and four notches 19c including two notches 19c on an edge at one end and two notches 19c on an edge at the other end. The depressions 19a each contain a pinion gear 23 (included in the magnet control mechanism 5C) meshing with two corresponding rack gears 18a. The holes 19b each receive, as disposed therethrough, such elements as a pinion shaft 23s supporting the corresponding pinion gear 23 in such a manner that the pinion gear 23 is rotatable. The notches 19c receive the rack gears 18a.

The guide plate 20 has two through holes 20a through which the respective pinion gears 23 are disposed. The guide plate 20 includes rails 20b supporting a coupler rack gear 24 (see FIGS. 2 and 3) in such a manner that the coupler rack gear 24 is slidable along the frame axis X. The present embodiment includes two pinion gears 23, but may alternatively include a single pinion gear 23. The present embodiment may alternatively omit the coupler rack gear 24.

Each operation lever 17 in the corresponding depression 5S in the handle 5 is urged by urging members 21 away from the frame axis X. The urging members 21 are each in the form of a block made of an elastomer or resin, and are disposed between the operation lever 17 and the guide block 19. With this configuration, the user gripping the handle 5 and displacing the operation levers 17 compresses the urging members 21, whereas the user releasing the grip allows each operation lever 17 to return to the released position due to the urging force of the urging members 21.

### Magnet Control Mechanism of Handle

As illustrated in FIGS. 2 to 4, the magnet control mechanism 5C includes a pair of pinion gears 23, a first intermediate gear 25, a second intermediate gear 26, and a rotor 27. The rotor 27 includes a sector gear 27a and a holder 27b holding the permanent magnet Mg and integrally including two rotary shafts 27s.

The description below deals with the magnet control mechanism 5C with reference to one of the pinion gears 23 as a first pinion gear, the other of the pinion gears 23 as a second pinion gear, those rack gears of the operation plates 18 which mesh with the first pinion gear as first rack gears, and those rack gears of the operation plates 18 which mesh with the second pinion gear as second rack gears. The pinion gears 23 mesh with the coupler rack gear 24.

As illustrated in FIGS. 2 to 4, the pinion gears 23 are each rotatably supported by its corresponding pinion shaft 23s. The first intermediate gear 25 is rotatably supported by a first shaft 25s. The second intermediate gear 26 is rotatably supported by a second shaft 26s.

The pinion shafts 23s, the first shaft 25s, and the second shaft 26s each have its opposite ends held by the respective inner surfaces of the frame bodies 14. The rotary shafts 27s are opposite to each other across the rotor 27, and are rotatably held by the respective inner surfaces of the frame bodies 14.

The pinion shafts 23s may be integral with the respective pinion gears 23. The first shaft 25s may be integral with the first intermediate gear 25. The second shaft 26s may be integral with the second intermediate gear 26. The rotary shafts 27s may be integral with the rotor 27.

The magnet control mechanism 5C is configured to rotate the permanent magnet Mg in conjunction with the rotor 27. The magnet control mechanism 5C may alternatively be configured to move the permanent magnet Mg in a straight line or arc or to rotate the permanent magnet Mg in a direction substantially orthogonal to the frame axis X (not illustrated in the drawings).

The pinion gears 23, the first intermediate gear 25, and the second intermediate gear 26 constitute a gear unit GU configured to convert the linear displacement of each operation lever 17 into a rotation and transmit the rotation to the rotor 27. The gears of the gear unit GU are each a two-speed gear including a small-diameter gear portion and a large-diameter gear portion. The gear unit GU accelerates the rotation as the pinion gears 23, the first intermediate gear 25, and the second intermediate gear 26 increase the rotation angle in this order.

The gear unit GU accelerates the rotation as follows: The pinion gears 23 each transmit rotation at its large-diameter gear portion to the small-diameter gear portion of the first intermediate gear 25, which then transmits rotation at its large-diameter gear portion to the small-diameter gear portion of the second intermediate gear 26, which then transmits rotation at its large-diameter gear portion to the sector gear 27a of the rotor 27.

The pinion gears 23 each have its small-diameter gear portion meshing with the coupler rack gear 24. This allows the pinion gears 23 to rotate at respective angles equal to each other due to the gripping force even if the user has gripped the handle 5 (pressure receivers 5B) unevenly. This in turn allows the operation levers 17 to be translated while in parallel to the frame axis X, and thereby allows the displacement to be transmitted to the gear unit GU.

As illustrated in FIG. 5, the permanent magnet Mg is a bar magnet with magnetic poles (namely, the north and south poles) at the respective ends. As illustrated in section (A) of FIG. 5 and FIG. 6, while the user is not gripping the handle 5, the operation levers 17 are each at the released position, that is, farthest from the frame axis X, due to the urging force of the urging members 21.

The first intermediate gear 25, the second intermediate gear 26, and the sector gear 27a of the gear unit GU are each an interlocking gear configured to transmit rotation of the pinion gears 23 to the rotor 27. The permanent magnet Mg is in the form of a block with magnetic poles (namely, the north and south poles) at the respective ends.

The control circuit 10 is configured to, in response to the handle 5 becoming attached properly to the device body 1 and the magnetic sensor S detecting magnetism of the permanent magnet Mg in the handle 5, determine on the basis of the direction of the magnetic field and the intensity of the magnetism (magnetic flux density) that a first condition is not satisfied, that is, the handle 5 has been attached properly. The control circuit 10 also determines that a second condition is not satisfied, in response to the handle 5 becoming attached properly to the device body 1 and the user not gripping the handle 5 or the user gripping the handle 5 improperly. The control circuit 10, in other words, determines that the second condition is satisfied, in response to the magnetic sensor S detecting the direction of the magnetic field and the intensity of the magnetism of the permanent magnet Mg in the handle 5 as gripped properly. The control circuit 10 also determines that a third condition is satisfied, in response to starting to detect magnetism at a predetermined level (that is, magnetism that satisfies the first condition and does not satisfy the second condition) after the second condition is satisfied, as when the force of gripping the handle 5 has been decreased. Satisfying the second and third conditions includes the handle 5 being attached properly to the device body 1. These control operations will be described below in greater detail.

While the handle 5 is unattached and the pressure receivers 5B are not displaced, the magnet control mechanism 5C keeps magnetism failing to satisfy the first condition which magnetism the permanent magnet Mg applies to the magnetic sensor S through the bolt 11 (which is an example of the “coupler”) made of a magnetic material. While the handle 5 is attached properly and the pressure receivers 5B are not displaced, the magnet control mechanism 5C keeps the magnetism satisfying the first condition.

In response to the user then gripping the handle 5 and displacing the pressure receivers 5B with a gripping force, the magnet control mechanism 5C rotates the permanent magnet Mg about the rotary shafts 27s by 90 degrees. This causes the magnetism to satisfy the second condition. The magnet control mechanism 5C, in other words, positions the magnetic poles of the permanent magnet Mg such that the magnetism satisfies the second condition. In response to the user turning on the electric power switch 4 while the magnetism satisfies the second condition, the control circuit 10 starts supplying electric current to the electric motor M.

In response to the user decreasing the force of gripping the handle 5 while the electric motor M is receiving electric current, the magnet control mechanism 5C positions the magnetic poles of the permanent magnet Mg such that the magnetism fails to satisfy the second condition and does satisfy the third condition. The control circuit 10, in response to determining that the magnetism satisfies the third condition, keeps supplying electric current to the electric motor M. The control circuit 10 keeps the supply as such only in response to the magnetism starting to fail to satisfy the second condition (that is, starting to satisfy the third condition).

In response to the user decreasing the force of gripping the handle 5 further than when the magnetism satisfies the third condition, the magnet control mechanism 5C positions the magnetic poles of the permanent magnet Mg such that the magnetism fails to satisfy the third condition. The control circuit 10, in response to determining that the magnetism fails to satisfy the third condition, starts to supply a limited amount of electric current to the electric motor M. The control circuit 10 starts and keeps the supply of a limited amount of electric current only in response to the magnetism starting to fail to satisfy the third condition.

The control circuit 10 keeps the electric current supply disabled while the magnetism fails to satisfy the first condition. In response to the magnetism starting to satisfy the first condition, the control circuit 10 enables the electric current supply. The control circuit 10, however, does not start supplying electric current to the electric motor M in response to the user turning on the electric power switch 4 if the control circuit 10 has only determined that the magnetism satisfies the first condition alone. The control circuit 10 starts supplying electric current to the electric motor M in response to the user turning on the electric power switch 4 only if (i) the user has gripped the handle 5 properly and (ii) the control circuit 10 has determined that the magnetism satisfies the second condition (that is, both the first and second conditions). The control circuit 10 keeps the supply of electric current to the electric motor M in response to determining that the magnetism fails to satisfy the second condition as a result of the gripping force being decreased but satisfies the third condition. In response to the control circuit 10 then determining that the magnetism has started to fail to satisfy the third condition as a result of the gripping force being decreased further, the disc grinder A transitions into a power-saving mode, that is, starts to supply a predetermined amount of electric current to the electric motor M.

The present embodiment is configured such that whether the first to third conditions are satisfied depends on either the intensity of magnetism applied to the magnetic sensor S or the combination of the intensity of the magnetism and the direction of the magnetic field. Magnetism applied to the magnetic sensor S satisfies the first condition if the magnetism has a predetermined direction and a predetermined intensity or higher. In this case, the magnetism may be exhibited by either the north or south pole, and may have its north and south poles positioned in accordance with the properties of the magnetic sensor S.

The control circuit 10 may be configured to, while the magnetism fails to satisfy the third condition, supply no electric current to the electric motor M instead of transitioning into the power-saving mode. The control circuit 10 may be configured to, in response to determining that the magnetism has started to fail to satisfy the third condition while it satisfies the first condition, stop the supply of electric current to the electric motor M.

The magnet control mechanism 5C may omit either or both of the first and second intermediate gears 25 and 26 in view of at least one of the size of the handle 5, the distance between the pressure receivers 5B and the bolt 11, and the size and shape of the permanent magnet Mg. The magnet control mechanism 5C may also include three or more intermediate gears.

### Operation

As illustrated in section (A) of FIG. 5, while the user is not gripping the handle 5 and the pressure receivers 5B are each at the released position, the magnet control mechanism 5C keeps the rotor 27 such that the permanent magnet Mg has its magnetic poles (namely, the north and south poles) arranged orthogonally to the frame axis X.

Orienting the permanent magnet Mg as above causes its magnetic poles to be farthest away from the head 11a of the bolt 11. The permanent magnet Mg thus applies magnetism weakest for the present embodiment to the magnetic sensor S through the bolt 11. This means that the magnet control mechanism 5C keeps the magnetism failing to satisfy the first condition.

The control circuit 10 (see FIG. 1) in the device body 1 may store a threshold for the output voltage from the magnetic sensor S (Hall device). The output voltage varies according to the intensity of magnetism (magnetic flux density) that the permanent magnet Mg applies to the magnetic sensor S. The threshold is set in accordance with (i) the intensity of magnetism, which changes depending on whether the user is gripping the handle 5, or (ii) the direction of the magnetic field and the intensity of magnetism.

With the above configuration, when the pressure receivers 5B are each at the released position as illustrated in section (A) of FIG. 5, the control circuit 10 determines on the basis of an output voltage from the magnetic sensor S that the user is not gripping the handle 5, and disables the supply of electric current to the electric motor M.

In response to the user gripping the handle 5 and pressing each pressure receiver 5B to the gripped position as illustrated in section (B) of FIG. 5, the magnet control mechanism 5C converts the linear displacement of each operation lever 17 into a rotation through the gear unit GU so that the permanent magnet Mg has its magnetic poles (namely, the north and south poles) arranged along the frame axis X (that is, in parallel to the frame axis X). More specifically, the magnet control mechanism 5C rotates the rotor 27 about the rotary shafts 27s by 90 degrees so that the permanent magnet Mg has its magnetic poles arranged along the frame axis X. This causes the direction of the magnetic field and the intensity of the magnetism applied to the magnetic sensor S to sequentially satisfy the first condition and the second condition.

Orienting the permanent magnet Mg as above causes one of its magnetic poles to be proximate to the head 11a of the bolt 11. The permanent magnet Mg thus intensifies the magnetism applied to the magnetic sensor S through the bolt 11.

With the above configuration, in response to the user pressing each pressure receiver 5B to the gripping position as illustrated in section (B) of FIG. 5, the control circuit 10 determines on the basis of an output voltage from the magnetic sensor S that the user is gripping the handle 5, and enables electric current to be supplied to the electric motor M. This means that the magnetism satisfies the second condition; that is, turning on the electric power switch 4 will start supply of electric current to the electric motor M to drive the electric motor M.

The disc grinder A may be configured to, in response to the gripping force becoming weak after the user grips the handle 5 for electric current to be supplied to the electric motor M, transition into the power-saving mode as long as magnetism applied to the magnetic sensor S satisfies the third condition even if it fails to satisfy the second condition.

The disc grinder A may be configured such that in response to the user weakening their grip of the handle 5 or releasing the handle 5 so that the magnetism starts to fail to satisfy the first condition after satisfying the second or third condition, the control circuit 10 stops supplying electric current to the electric motor M on the basis of an output voltage from the magnetic sensor S.

In the power-saving mode, the disc grinder A saves electric current by reducing the electric current to be supplied to the electric motor M while allowing electric current to be supplied to components other than the electric motor M. The disc grinder A may be configured to, for instance, turn on a lamp to indicate that the disc grinder A is in the power-saving mode or notify the user that the user is gripping the handle 5 with an insufficient force. The disc grinder A may also be configured in the power-saving mode to reduce electric current to be supplied to the electric motor M and thereby slow down the rotation of the disc 2 to make the user aware that the user is gripping the handle 5 with an insufficient force.

### Variation of Magnet Control Mechanism

As described above, the magnet control mechanism SC is configured to rotate the permanent magnet Mg about the rotary shafts 27s by 90 degrees. The magnet control mechanism 5C may alternatively be configured to rotate the permanent magnet Mg by 180 degrees.

In the above case, the magnetic sensor S is configured to discriminate between the magnetic poles so that the control circuit 10 is capable of detecting that the user is gripping the handle 5. Specifically, the magnet control mechanism 5C may be configured to, for instance, (i) position the north pole of the permanent magnet Mg close to the head 11a of the bolt 11 while the user is not gripping the handle 5 so that the operation levers 17 are not displaced and (ii) in response to the user gripping the handle 5 and displacing the operation levers 17, rotate the permanent magnet Mg by 180 degrees to bring the south pole close to the head 11a so that the control circuit 10 detects that the user is gripping the handle 5. During this operation, the second condition is satisfied if (i) the magnetic field extending from the bolt 11 to the south pole of the permanent magnet Mg has a predetermined direction, and (ii) the permanent magnet Mg applies from its south pole to the magnetic sensor S magnetism with a predetermined intensity or higher.

The magnet control mechanism 5C may be configured to rotate the permanent magnet Mg about the rotary shafts 27s by an angle other than 90 degrees or 180 degrees, for example, less than or more than 90 degrees.

### Advantages of Embodiments

The disc grinder A is configured to keep the electric motor M disabled while the handle 5 is attached improperly or the user is gripping the handle 5 improperly and to enable the electric motor M to operate if the handle 5 is attached properly and the user is gripping the handle 5 properly.

The disc grinder A determines that the user has gripped the handle 5 properly, as the magnet control mechanism 5C amplifies slight displacement of the operation levers 17 resulting from the grip and rotates the permanent magnet Mg by 90 degrees. This eliminates the need for the user to grip the handle 5 and displace each operation lever 17 by a large stroke, and thereby eliminates the need to include a handle 5 with an inconveniently large outer diameter.

The handle 5 includes a connector 5A to be coupled to the device body 1, the connector 5A including a bolt 11 which is made of a magnetic material such as steel and at least a portion of which serves to allow the permanent magnet Mg to apply its magnetism to the magnetic sensor S. The use of the bolt 11 eliminates the need to separately include a dedicated coupler such as a yoke.

The disc grinder A is configured such that rotating the permanent magnet Mg in the vicinity of the head 11a of the bolt 11 (that is, the end on the side of the handle 5) allows the permanent magnet Mg to apply its magnetism (magnetic flux) to the magnetic sensor S through the bolt 11. This configuration increases the degree of freedom in positioning the permanent magnet Mg and facilitates designing the handle 5, as compared to a case of, for instance, a permanent magnet Mg applying its magnetic flux directly to a magnetic sensor S.

The magnet control mechanism 5C includes a pair of pinion gears 23 so interlocked with each other by a coupler rack gear 24 as to convert movement (that is, linear displacement) of each operation lever 17 into a rotation. Thus, gripping the handle 5 (pressure receivers 5B) unevenly still causes the operation levers 17 to be translated while in parallel to the frame axis X for transmission of the displacement to the gear unit GU. This allows the control circuit 10 to detect whether the user is gripping the handle 5, on the basis of an output voltage from the magnetic sensor S which output voltage depends on how the permanent magnet Mg applies its magnetism to the magnetic sensor S (for instance, as a result of the user weakening their grip).

The disc grinder A transitioning into the power-saving mode makes the user aware that the user is gripping the handle 5 with an insufficient force.

The magnet control mechanism 5C is contained in the frame 5D and mechanically operable in response to the user gripping the handle 5. This eliminates the need for the connector 5A to include components such as an electric contact and an electric wire, thereby eliminating the need to route an electric wire during the production process and the possibility of failing to detect the user's grip due to contact failure resulting from corrosion, abrasion, deformation, or the like of an electric contact or to breakage of an electric wire. Further, the frame 5D contains a permanent magnet Mg and a magnet control mechanism 5C configured to position the magnetic poles of the permanent magnet Mg away from the bolt 11 when the pressure receivers 5B are each at the released position. This structure almost completely prevents the permanent magnet Mg from applying its magnetism to a threadedly engageable portion 8a of the nut 8 on the device body 1 which threadedly engageable portion 8a is not covered by the holder 12 of the bolt 11. This prevents the nut 8 (that is, the vicinity of the threadedly engageable portion 8a) from easily attracting a magnetic substance such as iron powder while the user is not gripping the handle 5 because the threadedly engageable portion 8a does not receive magnetism, and thereby reduces the risk of the magnetic substance (foreign substance) being stuck between the bolt 11 and the nut 8 and the resulting defect in attaching the handle 5.

### Alternative Embodiments

This disclosure may be configured as below in addition to the embodiments described above. Any element described below that functions as described for the embodiments above is assigned with the same reference numeral as that for embodiments above.

(a) The disc grinder A may be configured to determine in response to the handle 5 becoming attached to the device body 1 that the handle 5 has been attached properly to the device body 1, on the basis of the intensity of magnetism (magnetic flux density) that the permanent magnet Mg applies to the magnetic sensor S through the bolt 11, even if the user is not gripping the handle 5 and pressing the operation levers 17.

Specifically, while the user is not pressing the operation levers 17, the magnetic sensor S is still able to detect a certain level of magnetism applied from the permanent magnet Mg through the bolt 11 although the level is not so high as to satisfy the first and second conditions. The disc grinder A may thus be configured to determine whether the handle 5 has been attached, on the basis of, for example, a certain intensity of magnetism as a condition.

The electrically drivable device in the form of alternative embodiment (a) operates on the basis of two conditions: (i) the direction of the magnetic field and the intensity of the magnetism that the magnetic sensor S detects in response to the handle 5 becoming attached to the device body 1, and (ii) the direction of the magnetic field and the intensity of the magnetism that the magnetic sensor S detects in response to the user gripping the handle 5 with the handle 5 attached to the device body 1. The electrically drivable device may be configured to operate depending on whether the conditions are each satisfied or not. The two conditions (namely, the first and second conditions) may be the same as each other. The electrically drivable device may alternatively be configured to operate on the basis of three or more conditions.

The above configuration allows the electrically drivable device to determine, for instance, that the handle 5 is unattached to the device body 1 or that the handle 5 is not fully attached. The electrically drivable device may also be configured to, for instance, turn on a lamp to make the user aware that the handle 5 is not attached properly.

To determine while the user is not gripping the handle 5 whether the handle 5 is attached properly, the electrically drivable device may be configured such that (i) while the user is not gripping the handle 5, the permanent magnet Mg is so tilted that that magnetic pole (that is, either the north pole or the south pole) which the magnetic sensor S is able to detect is closer to the magnetic sensor S and that (ii) while the user is gripping the handle 5 properly, the permanent magnet Mg is so oriented that that magnetic pole which the magnetic sensor S is able to detect faces the magnetic sensor S or is tilted as above.

(b) The handle 5 (attachment) may be in the form of a bar made of a magnetic material and having at least one engageable nail (coupler) at its leading end. The nail is a bayonet-type coupler engageable with nails (connector member) of the device body 1 as the handle 5 is rotated about the frame axis X. The handle 5 may alternatively be in the form of a bar made of a magnetic material and having an engageable depression (coupler) at its leading end. The depression may be engaged with a lock member (connector member) to prevent detachment of the handle 5, and serves as an alternative connection mechanism for coupling with the device body 1.

As described above, the coupler for attaching the handle 5 to the device body 1 is not necessarily a bolt 11. The connector member for coupling the coupler with the device body 1 is not necessarily a nut 8. Further, the electrically drivable device may include two or more couplers and/or connector members.

(c) The electrically drivable device may, for instance, include a magnetic element such as a piece of iron (which may be regarded as a yoke) on the back surface of the magnetic sensor S (that is, the surface opposite to the bolt 11) or in the vicinity of the magnetic sensor S for the magnetic sensor S to receive magnetism with a higher intensity. The electrically drivable device may alternatively include, for example, a magnetic shield in the vicinity of the magnetic sensor S to prevent magnetism outside the device body 1 from acting on the magnetic sensor S and thereby causing a detection error while the handle 5 is unattached to the device body 1.

(d) The disc grinder A (electrically drivable device) may be configured to allow the electric motor M to be driven in response to the electric power switch 4 being turned on only after the user has gripped the handle 5 and turned the handle 5 about the frame axis X.

Alternative embodiment (d) requires not only a mechanism for detecting that the user has gripped the handle 5 and pressed the pressure receivers 5B as described for the embodiment described above under “Description of Embodiments” (hereinafter referred to as “first embodiment”), but also elements such as a switch for detecting that the user has turned the handle 5. However, alternative embodiment (d), which allows the electric motor M to be driven on the basis of the user gripping and turning the handle 5, reduces the risk of erroneously driving the electric motor M.

(e) The magnet control mechanism 5C may be configured to transmit displacement of the operation levers 17 to the rotor 27 with use of not gears but at least one rod and/or wire to rotate the rotor 27 about the rotary shafts 27s. The disc grinder A may, in this case, configured such that only either of the two operation levers 17 is displaceable.

The magnet control mechanism 5C for alternative embodiment (e) may be configured, for instance, such that the operation levers 17 are interlocked with each other with use of a pantograph-type link so that the user pressing the operation levers 17 with their gripping force displaces the link and transmits the displacement to the rotor 27 through the at least one rod and/or wire. The disc grinder A may, in this case, configured such that only either of the two operation levers 17 is displaceable.

(f) The magnet control mechanism 5C may be configured to not use gears but convert displacement of the operation levers 17 into a fluid pressure and transmit the pressure to the rotor 27 to rotate the rotor 27 about the rotary shafts 27s. The disc grinder A may, in this case, configured such that only either of the two operation levers 17 is displaceable.

The magnet control mechanism 5C for alternative embodiment (f) may, for instance, include a container such as a chamber or a bellows with a volume changeable in response to displacement of the operation levers 17, a fluid such as oil sealed in the container, and an element such as a cylinder configured to rotate the rotor 27 for the first embodiment in response to receiving the oil pressure.

(g) The magnet control mechanism 5C may include an elastic member in an area extending from a position proximate to the operation levers 17 to a position proximate to the rotor 27 for the first embodiment. The elastic member is deformed in response to pressure from the operation levers 17, and returns to its original shape in response to the pressure being removed. The elastic member transmits pressure that deforms it to the rotor 27 directly to rotate the rotor 27, and allows the rotor 27 to return to its original orientation in response to the pressure being removed.

The magnet control mechanism 5C for alternative embodiment (g) may omit a mechanically operable mechanism such as gears and instead include an elastic member only. In this case, the magnet control mechanism 5C may be configured to, for instance, bring the permanent magnet Mg close to the head 11a of the bolt 11 in response to pressure and move the permanent magnet Mg away from the head 11a in response to a decrease in the pressure. The magnet control mechanism 5C may include a mechanical arrangement to assist in rotating the permanent magnet Mg as in the first embodiment in response to the elastic member receiving pressure and the pressure being removed.

(h) The magnet control mechanism 5C may be configured to move the permanent magnet Mg along the frame axis X to switch between a position close to the inner end of the bolt 11 (that is, the end on the side of the handle 5) and a position apart from it.

Alternative embodiments (a) to (h) may each be configured to positionally switch the magnetic poles of the permanent magnet Mg by not rotating the permanent magnet Mg but moving the permanent magnet Mg in a straight line or arc, for example.

(i) The urging members 21 are not necessarily made of an elastomer, and may be in the form of a spring such as a compression spring or a plate spring to reliably move each operation lever 17 to the released position.

(j) The electrically drivable device may omit the feeder line 6 and contain a secondary battery configured to supply electric power to the electric motor M to drive the electric motor M.

(k) The handle 5 may include, instead of a pair of operation levers 17, only one operation lever 17 or three or more operation levers 17.

The handle 5 may include a single pinion gear 23 and a single operation plate 18 for a pressure receiver 5B with a single rack gear 18a.

(1) The electrically drivable device is not necessarily a disc grinder A, and may be another electric power tool such as a handy drill (that is, a type of drilling tool) or a driver for tightening a bolt or the like.

1. An electrically drivable device, comprising:
a device body; and
an attachment attachable to and detachable from the device body,
the attachment including:
a connector connectable with the device body;
at least one pressure receiver displaceable inward in response to a gripping force with which a user grips the attachment;
a permanent magnet;
a magnet control mechanism configured to move the permanent magnet or change an orientation thereof in conjunction with the displacement of the at least one pressure receiver; and
a frame holding the at least one pressure receiver in such a manner that the at least one pressure receiver is displaceable, and containing the magnet control mechanism,
the device body including a magnetic sensor configured to, in response to the at least one pressure receiver being displaced with the attachment attached to the device body, detect magnetism that the permanent magnet applies through at least a portion of the connector.

2. The electrically drivable device according to claim 1, wherein
the device body includes a connection keeper configured to be coupled with a coupler of the attachment to allow the attachment to be coupled with the device body.

3. The electrically drivable device according to claim 1, wherein
the connector includes a coupler made of a magnetic material,
the device body includes a connection keeper configured to be coupled with a tip of the coupler to allow the attachment to be coupled with the device body, and
the permanent magnet applies the magnetism to the magnetic sensor through the coupler.

4. The electrically drivable device according to claim 3, wherein
the magnet control mechanism positions magnetic poles of the permanent magnet such that while the at least one pressure receiver is not displaced, the magnetism does not satisfy a first condition and that in response to the at least one pressure receiver being displaced by the gripping force, the magnetism starts to satisfy a second condition.

5. The electrically drivable device according to claim 4, wherein
while the magnetism does not satisfy the first condition, the electrically drivable device is unable to receive electric current, in response to the magnetism starting to satisfy the first condition as a result of
the displacement of the at least one pressure receiver, the electrically drivable device starts to be able to receive electric current,
while the magnetism satisfies the first and second conditions, the electrically drivable device is able to start receiving electric current, and
even if, while the electrically drivable device is receiving electric current, the magnetism has started to fail to satisfy the second condition while satisfying the first condition, the electrically drivable device is able to continue receiving electric current.

6. The electrically drivable device according to claim 4, wherein
in response to the at least one pressure receiver being displaced by the gripping force, the magnet control mechanism positions or orients the magnetic poles of the permanent magnet such that the magnetism satisfies the first condition and fails to satisfy a third condition, and
the electrically drivable device is able to save electric current if the magnetism satisfies the first condition and fails to satisfy the third condition.

7. The electrically drivable device according to claim 5, wherein
in response to the at least one pressure receiver being displaced by the gripping force, the magnet control mechanism positions or orients the magnetic poles of the permanent magnet such that the magnetism satisfies the first condition and fails to satisfy a third condition, and
the electrically drivable device is able to save electric current if the magnetism satisfies the first condition and fails to satisfy the third condition.

8. The electrically drivable device according to claim 4, wherein
the magnet control mechanism includes:
a rotor holding the permanent magnet in such a manner that the permanent magnet is rotatable; and
a gear unit configured to convert the displacement of the at least one pressure receiver into a rotation and transmit the rotation to the rotor, and
in response to the at least one pressure receiver being displaced, the rotor rotates to bring one of the magnetic poles of the permanent magnet close to the coupler for the magnetism to be applied to the magnetic sensor.

9. The electrically drivable device according to claim 5, wherein
the magnet control mechanism includes:
a rotor holding the permanent magnet in such a manner that the permanent magnet is rotatable; and
a gear unit configured to convert the displacement of the at least one pressure receiver into a rotation and transmit the rotation to the rotor, and
in response to the at least one pressure receiver being displaced, the rotor rotates to bring one of the magnetic poles of the permanent magnet close to the coupler for the magnetism to be applied to the magnetic sensor.

10. The electrically drivable device according to claim 6, wherein
the magnet control mechanism includes:
a rotor holding the permanent magnet in such a manner that the permanent magnet is rotatable; and
a gear unit configured to convert the displacement of the at least one pressure receiver into a rotation and transmit the rotation to the rotor, and
in response to the at least one pressure receiver being displaced, the rotor rotates to bring one of the magnetic poles of the permanent magnet close to the coupler for the magnetism to be applied to the magnetic sensor.

11. The electrically drivable device according to claim 7, wherein
the magnet control mechanism includes:
a rotor holding the permanent magnet in such a manner that the permanent magnet is rotatable; and
a gear unit configured to convert the displacement of the at least one pressure receiver into a rotation and transmit the rotation to the rotor, and
in response to the at least one pressure receiver being displaced, the rotor rotates to bring one of the magnetic poles of the permanent magnet close to the coupler for the magnetism to be applied to the magnetic sensor.

12. The electrically drivable device according to claim 8, wherein
the at least one pressure receiver includes a pair of pressure receivers opposite to each other across a frame axis of the frame which frame axis extends in a longitudinal direction of the frame,
the pressure receivers are configured such that in response to the user gripping the attachment, at least either of the pressure receivers is displaced in such a direction that the pressure receivers become closer to each other, and
the gear unit includes:
at least one pinion gear meshing with a rack gear on each of a pair of operation plates movable in conjunction with the respective pressure receivers; and
a plurality of interlocking gears configured to transmit a rotation of the at least one pinion gear to the rotor.

13. The electrically drivable device according to claim 9, wherein
the at least one pressure receiver includes a pair of pressure receivers opposite to each other across a frame axis of the frame which frame axis extends in a longitudinal direction of the frame,
the pressure receivers are configured such that in response to the user gripping the attachment, at least either of the pressure receivers is displaced in such a direction that the pressure receivers become closer to each other, and
the gear unit includes:
at least one pinion gear meshing with a rack gear on each of a pair of operation plates movable in conjunction with the respective pressure receivers; and
a plurality of interlocking gears configured to transmit a rotation of the at least one pinion gear to the rotor.

14. The electrically drivable device according to claim 10, wherein
the at least one pressure receiver includes a pair of pressure receivers opposite to each other across a frame axis of the frame which frame axis extends in a longitudinal direction of the frame,
the pressure receivers are configured such that in response to the user gripping the attachment, at least either of the pressure receivers is displaced in such a direction that the pressure receivers become closer to each other, and
the gear unit includes:
at least one pinion gear meshing with a rack gear on each of a pair of operation plates movable in conjunction with the respective pressure receivers; and
a plurality of interlocking gears configured to transmit a rotation of the at least one pinion gear to the rotor.

15. The electrically drivable device according to claim 11, wherein
the at least one pressure receiver includes a pair of pressure receivers opposite to each other across a frame axis of the frame which frame axis extends in a longitudinal direction of the frame,
the pressure receivers are configured such that in response to the user gripping the attachment, at least either of the pressure receivers is displaced in such a direction that the pressure receivers become closer to each other, and
the gear unit includes:
at least one pinion gear meshing with a rack gear on each of a pair of operation plates movable in conjunction with the respective pressure receivers; and
a plurality of interlocking gears configured to transmit a rotation of the at least one pinion gear to the rotor.

16. The electrically drivable device according to claim 12, wherein
the at least one pinion gear includes:
a first pinion gear; and
a second pinion gear,
the first pinion gear meshes with a first rack gear, the first rack gear being the rack gear on a first operation plate of the pair of operation plates,
the second pinion gear meshes with a second rack gear, the second rack gear being the rack gear on a second operation plate of the pair of operation plates, and
the attachment includes a coupler rack gear interlocking the first pinion gear with the second pinion gear.

17. The electrically drivable device according to claim 13, wherein
the at least one pinion gear includes:
a first pinion gear; and
a second pinion gear,
the first pinion gear meshes with a first rack gear, the first rack gear being the rack gear on a first operation plate of the pair of operation plates,
the second pinion gear meshes with a second rack gear, the second rack gear being the rack gear on a second operation plate of the pair of operation plates, and
the attachment includes a coupler rack gear interlocking the first pinion gear with the second pinion gear.

18. The electrically drivable device according to claim 14, wherein
the at least one pinion gear includes:
a first pinion gear; and
a second pinion gear,
the first pinion gear meshes with a first rack gear, the first rack gear being the rack gear on a first operation plate of the pair of operation plates,
the second pinion gear meshes with a second rack gear, the second rack gear being the rack gear on a second operation plate of the pair of operation plates, and
the attachment includes a coupler rack gear interlocking the first pinion gear with the second pinion gear.

19. The electrically drivable device according to claim 1, wherein
the attachment includes in the frame an urging member configured to, in response to the at least one pressure receiver being displaced, urge the at least one pressure receiver away from a frame axis of the frame which frame axis extends in a longitudinal direction of the frame.

20. The electrically drivable device according to claim 19, wherein
the urging member includes at least one of an elastomer, a coil spring, or a plate spring.
